(19) United States
(12) Patent Application Publication
(10) Pub. No.: US 2005/0213154 A1
(43) Pub. Date: Sep. 29, 2005

(54) Printing device and medium type setting method

(75) Inventors: Atsushi Narusawa, Nagano-ken (JP); Satoru Orii, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/038,480

(22) Filed: Jan. 21, 2005

(30) Foreign Application Priority Data
Jan. 20, 2004 (JP) 2004-11713

(51) Int. Cl. G06F 15/00

(52) U.S. Cl. 358/1.18

(57) ABSTRACT

The processing flow of the invention calculates a total image area S or a sum of areas of images among elements laid out on a 1^{st} page (step S306), and computes an image area ratio ρ of the total image area S to a total paper area A of the currently set paper size (step S308). The calculated image area ratio ρ of greater than a preset reference value ρref leads to selection of ‘Photo Paper’ as the paper type (step S312). The calculated image area ratio ρ of not greater than the preset reference value ρref, on the other hand, leads to selection of ‘Plain Paper’ as the paper type (step S314). The processing flow subsequently determines whether the selected paper type is inconsistent with the paper type currently set in a printer (step S316). In the case of inconsistency of the paper type, the processing flow outputs a display of the type and the size of printing paper to be set in the printer (step S318) and waits for entry of the user's confirmation (step S320).

### BACKGROUND OF THE INVENTION

1. Field of the Invention

The present invention relates to a printing device and a medium type setting method. More specifically the invention pertains to a printing device that analyzes a document, which describes printable objects in a hierarchical manner, and prints the objects on a medium, such as paper, as well as to a medium type setting method that sets the type of a medium, such as paper, in the process of analyzing a document, which describes printable objects in a hierarchical manner, and printing the objects on the medium.

2. Description of the Prior Art

One proposed printer system includes a printer that analyzes and prints an SVG document and a formatting server that converts an HTML document into the SVG document (see, for example, Reference 1: Japanese Patent Laid-Open Gazette No. 2002-91726). In this proposed printer system, the formatting server converts a received HTML document into an SVG document, and the printer analyzes and prints the converted SVG document.

### SUMMARY OF THE INVENTION

The prior art printer system including the printer and the formatting server is, however, undesirably large in size and is unsuitable for a restricted space, such as a living room in a house. This printer system converts the received HTML document into the SVG document and analyzes and prints the converted SVG document. Such conversion and analysis take a relatively long time and undesirably interfere with prompt printing. This prior art printer system, however, performs printing regardless of the type of the printing paper currently set in the printer. The printing paper may thus be unsuitable for the specified print contents, for example, photographs printed on plain papers and texts printed on photo papers.

The printing device of the invention thus aims to adequately analyze and print a document, such as an XHTML document or an extended XHTML document. The printing device of the invention also aims to set the type of a printing medium suitable for specified print contents in the process of analyzing and printing a document, such as an XHTML document or an extended XHTML document. The medium type setting method of the invention aims to set the type of a printing medium suitable for specified print contents in the process of analyzing and printing a document, such as an XHTML document or an extended XHTML document.

At least part of the above and the other related objects is attained by a printing device and a medium type setting method of the invention having the configurations discussed below.

A first printing device of the invention is a printing device that analyzes a document, which describes printable objects in a hierarchical manner, and prints the objects on a medium, such as paper, and the printing device includes: a structural analysis module that analyzes the document to identify a type of each object and a hierarchical tree structure of the objects in the document; a layout setting module that specifies a layout of the objects in each page on the medium, based on the identified tree structure; a medium type setting module that sets a type of the medium according to the types of the objects in the identified tree structure; and a print execution module that actually lays out and prints the objects in each page on the medium according to the specified layout.

The first printing device of the invention analyzes a document, which describes printable objects in a hierarchical manner, to identify the type of each object and the hierarchical tree structure of the objects in the document. The first printing device specifies the layout of the objects in each page on the medium based on the identified tree structure, and sets the type of the medium according to the types of the objects in the identified tree structure. The objects are laid out and printed in each page on the medium according to the specified layout. This arrangement appropriately analyzes and prints each document and sets the adequate type of the printing medium corresponding to the identified type of major objects, that is, the print contents.

In the first printing device of the invention, the medium type setting module may set the type of the medium according to the layout specified by the layout setting module. In this case, the medium type setting module may set the type of the medium according to an image object ratio in the specified layout. Further, in this case, the medium type setting module may select a photo medium corresponding to the image object ratio of not less than a preset level, while selecting a plain medium corresponding to the image object ratio of less than the preset level.

The first printing device of the invention may further include a medium feeder module that has an attachment unit for separately setting multiple different types of media in the printing device, and the medium feeder module selects a certain type of medium identical with the type of the medium set by the medium type setting module and feeds the selected type of medium to said print execution module. The first printing device may further include a medium type output module that has an output unit for outputting a type of medium in an identifiable manner, and the medium type output module outputs the type of the medium set by the medium type setting module in an identifiable manner to the output unit.

A second printing device of the invention is a printing device that analyzes a document, which describes printable objects, and prints the objects on a medium, such as paper, and the printing device includes: an object type identification module that analyzes the document to identify a type of each object described in the document; and a medium type setting module that sets a type of the medium according to the identified types of the objects.

The second printing device of the invention analyzes a document, which describes printable objects, to identify the type of each object in the document, and sets the type of the medium according to the identified types of the objects. This arrangement ensures adequate setting of the printing medium corresponding to the identified type of major objects, that is, the print contents.

In the second printing device of the invention, the medium type setting module may set the type of the medium according to a ratio of image objects to all the objects of the identified types. In this case, the medium type setting module may select a photo medium corresponding to the image object ratio of not less than a preset level, while selecting a plain medium corresponding to the image object ratio of less than the preset level.

The second printing device of the invention may further include a medium feeder module that has an attachment unit for separately setting multiple different types of media in the printing device, and the medium feeder module selects a certain type of medium identical with the type of the medium set by the medium type setting module and feeds the selected type of medium to said print execution module. The second printing device may further include a medium type output module that has an output unit for outputting a type of medium in an identifiable manner, and the medium type output module outputs the type of the medium set by the medium type setting module in an identifiable manner to the output unit.

The technique of the present invention is not restricted to the first printing device or the second printing device described above, but is also actualized by a medium type setting method that sets the type of a medium, such as paper, in the process of analyzing a document, which describes printable objects in a hierarchical manner, and printing the objects on the medium.

### BRIEF DESCRIPTION OF THE DRAWINGS

FIG. 1 schematically illustrates the structure of a color inkjet printer 20 in one embodiment;

FIG. 2 is a flowchart showing an analysis layout instruction process;

FIG. 3 is a flowchart showing an analysis process;

FIG. 4 shows one example of an XHTML document;

FIG. 5 shows images described in the XHTML document of the example;

FIG. 6 shows one example of a DOM tree;

FIG. 7 shows one example of a CSS document;

FIG. 8 shows one example of a style object;

FIG. 9 is a flowchart showing a layout drawing instruction process;

FIG. 10 is a flowchart showing a layout process;

FIG. 11 shows one example of a page box;

FIG. 12 is a flowchart showing a drawing process;

FIG. 13 shows one example of a printing result; and

FIG. 14 is a flowchart showing a modified analysis process.

### DESCRIPTION OF THE PREFERRED EMBODIMENTS

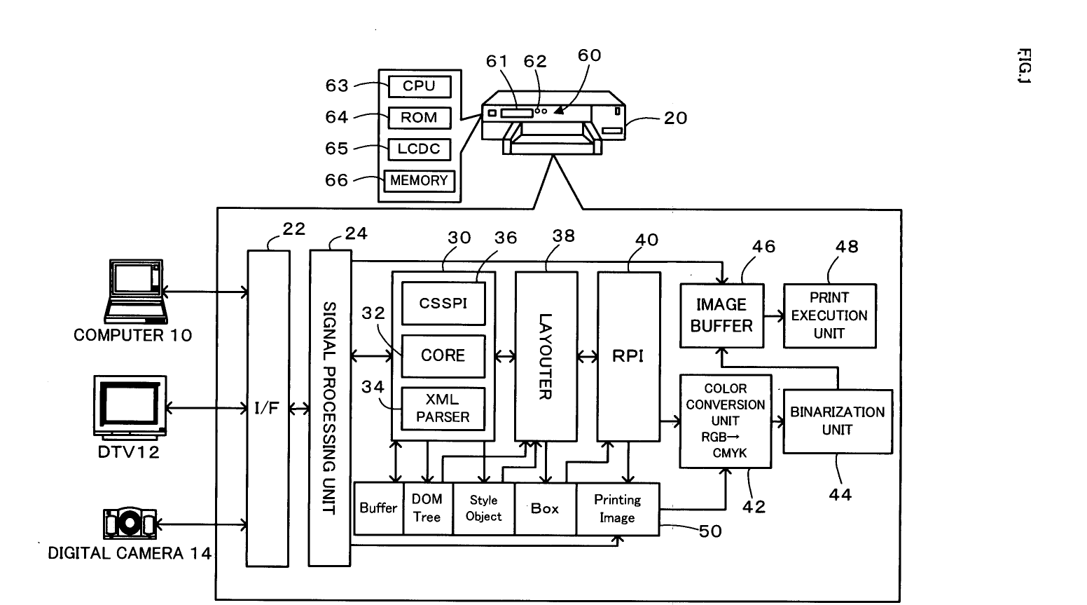

One mode of carrying out the invention is described below as a preferred embodiment. FIG. 1 schematically illustrates the structure of a color inkjet printer 20 in one embodiment of the invention. The color inkjet printer 20 of this embodiment includes an input interface 22 that is connected with a computer 10, a digital TV receiver 12, or a digital camera 14 to input digital images (hereafter simply referred to as images), a signal processing unit 24 that determines an output destination of data according to the format of each image input by the input interface 22, and an analyzer unit 30 that analyzes an XHTML document described in a markup language XHTML (eXtensible Hyper Text Markup Language) to create a DOM (Document Object Model) tree as an object tree structure, reads a CSS (Cascading Style Sheets) document described in CSS to create a style object, and writes the DOM tree and the style object into a memory 50. The color inkjet printer 20 also includes a layouter 38 that lays out images and text as objects described in the XHTML document on each printing page based on the DOM tree and the style object created by the analyzer unit 30 and writes each laid out printing page as a page box into the memory 50, a rendering plug-in (hereafter referred to as RPI) 40 that draws a printing image in the form of RGB (red, green, blue) data by utilizing the page box laid out by the layouter 38, a color conversion unit 42 that converts a printing image of the drawn RGB data into CMYK (cyan, magenta, yellow, black) data, a binarization unit 44 that makes the converted CMYK data subjected to error diffusion or another required series of image processing to binarize the CMYK data, and an image buffer 46 that temporarily accumulates data in order to output the binarized CMYK data in units of bands to a print execution unit 48 with a non-illustrated print head.

The signal processing unit 24 outputs immediately-printable print data to the image buffer 46 of the print execution unit 48, RGB data to a printing image storage area of the memory 50, and a file of the XHTML document to the analyzer unit 30.

The analyzer unit 30 includes a core 32 that gives an analysis command for analysis of the XHTML document to create the DOM tree, an XML parser 34 that analyzes the XHTML document in response to the analysis command given by the core 32, and a CSS plug-in (hereafter referred to as CSSPI) 36 that analyzes the CSS document in response to a request given by an initialization process in a link tag of the created DOM tree.

An operation unit 60 has a liquid crystal display 61 located on the front of the printer 20 and two operation buttons 62 provided by the side of the liquid crystal display 61. The operation unit 60 internally has a one-chip microcomputer including a CPU 63, a ROM 64, a display controller (hereafter referred to as LCDC) 65, and a memory 66. The operation unit 60 is manipulated to set, for example, the type and the size of printing paper and the type of inks currently set in the printer 20. In response to the user's press of the operation button 62, a processing program stored in advance in the ROM 64 is activated to display a menu for settings on the liquid crystal display 61. For example, in the case of setting the paper type, the user selects a paper type setting option in the displayed menu and chooses a desired paper type among available options, such as ‘Plain Paper’ and ‘Photo Paper’, displayed in toggle on the liquid crystal display 61. In the case of setting the paper size, the user selects a paper size setting option in the displayed menu and chooses a desired paper size among available options, such as ‘A4 Portrait’ and ‘B5 Portrait’, displayed in toggle on the liquid crystal display 61. The selected settings are written into the memory 66. In the structure of this embodiment, prior to the user's individual settings through manipulation of the operation unit 60, there are default settings, for example, ‘Plain Paper’ as the paper type, ‘A4 Portrait’ as the paper size, and ‘Pigment’ as the ink type. The user's settings with the operation unit 60 are not characteristic of the present invention and are thus not described in detail.

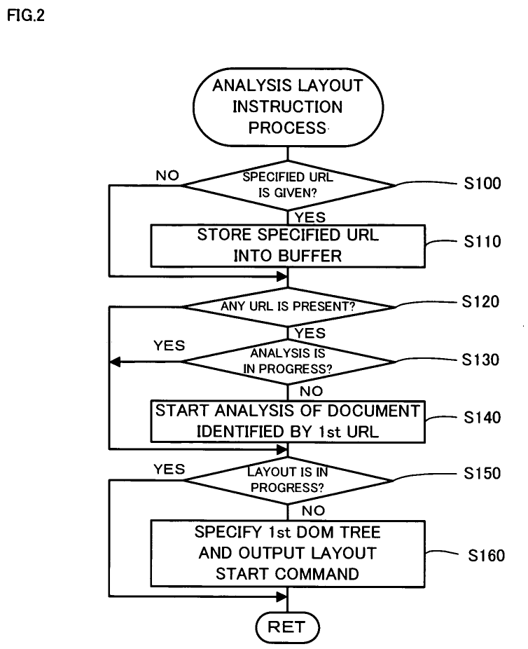

The following describes operations of the color inkjet printer 20 of the embodiment constructed as discussed above, especially a series of operations to print an XHTML document. FIG. 2 is a flowchart showing an analysis layout instruction process executed by the analyzer unit 30. This process is executed repeatedly at preset time intervals (for example, at every 8 msec). In the analysis layout instruction process, the analyzer unit 30 first determines whether a specified URL (Uniform Source Locator) is given to identify an XHTML document (step S100). When a specified URL is given, the URL is stored in a URL storage buffer area set in the memory 50 (step S110). When no specified URL is given, on the other hand, the program proceeds to a next step. The specified URL may be output, for example, from the digital TV receiver 12 to the color inkjet printer 20 when the user selects a desired object to be printed by the color inkjet printer 20 among printable objects displayed on the digital TV receiver 12. The specified URL may be selected simply by the computer 10 to give a print command to the color inkjet printer 20. The computer 10 has functions of executing analysis of the XHTML document, layout, color conversion, and binarization. The computer 10 may, however, not execute any of such processing but may send only the specified URL to the color inkjet printer 20.

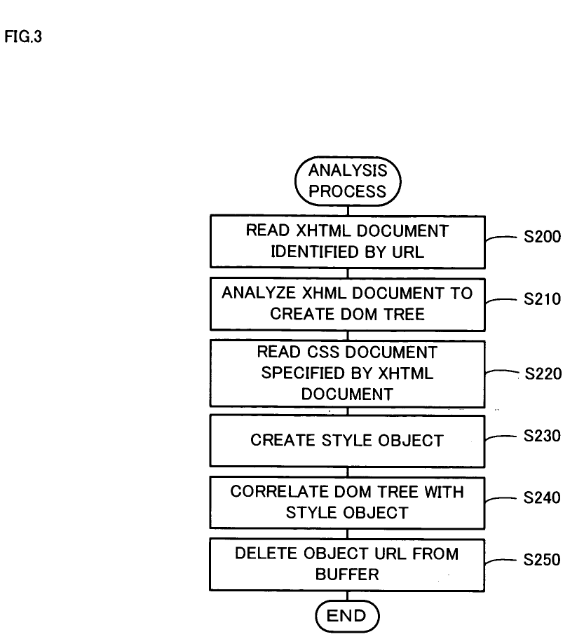

The analyzer unit 30 subsequently determines whether any URL is present in the URL storage buffer area of the memory 50 (step S120) and whether any XHTML document is currently being analyzed (step S130). The analyzing status of an XHTML document is detected, for example, by determining whether the analyzer unit 30 is currently analyzing any XHTML document, simultaneously with and in parallel with this analysis layout instruction process. One concrete procedure may set and reset a flag at the start and the end of analysis. When any URL is present in the URL storage buffer area and no XHTML document is currently being analyzed, the analyzer unit 30 reads out a 1^{st} URL stored in the URL storage buffer area of the memory 50 and starts analysis of an XHTML document specified by the read out URL (step S140). When no URL is present in the URL storage buffer area or when any URL is present but an XHTML document is currently being analyzed, on the other hand, the program proceeds to a next step. Analysis of the XHTML document is carried out according to an analysis process shown in FIG. 3. The analysis process analyzes an XHTML document specified by a URL to create a DOM tree, analyzes a CSS document specified by the XHTML document to create a style object, correlates the DOM tree with the style object, and stores the correlated DOM tree and style object respectively into a DOM tree storage area and a style object storage area of the memory 50. A DOM tree ID as identification information is assigned to the DOM tree, whereas a style object ID as identification information is assigned to the style object. The details of the analysis process will be discussed later.

The analyzer unit 30 then determines whether the layouter 38 is currently making a layout (step S150). When the layouter 38 is not currently making a layout, the analyzer unit 30 specifies a 1^{st} DOM tree with the DOM tree ID among DOM trees stored in the DOM tree storage area of the memory 50 and outputs a layout start command to the layouter 38 (step S160), before terminating this analysis layout instruction process. When the layouter 38 is currently making a layout, on the other hand, the analyzer unit 30 terminates the analysis layout instruction process without outputting a layout start command. The layout execution status of the layouter 38 is determined, for example, by detection of input of a layout end signal from the layouter 38. The input of the layout end signal will be described later as part of the processing by the layouter 38.

The analysis layout instruction process is executed in a repeated manner as mentioned above. Every time a specified URL is given, the analyzer unit 30 stores the specified URL into the URL storage buffer area of the memory 50, whether or not an XHTML document is being analyzed. When any URL is present in the URL storage buffer area of the memory 50, the analyzer unit 30 successively analyzes XHTML documents, whether or not the layouter 38 is currently making a layout. This may result in storage of multiple URLs in the URL storage buffer area, storage of multiple DOM trees in the DOM tree storage area, and storage of multiple style objects in the style object storage area of the memory 50. In the structure of this embodiment, the URL storage buffer area, the DOM tree storage area, and the style object storage area are respectively set to have the capacities for storing the multiple URLs, the multiple DOM trees, and the multiple style objects.

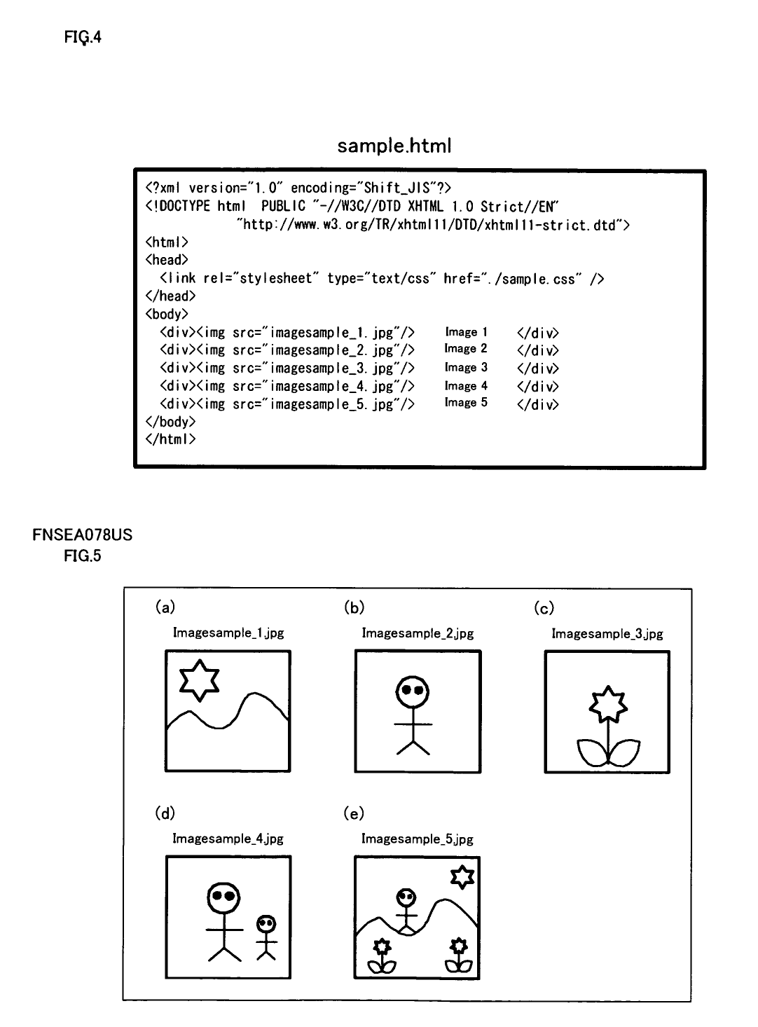

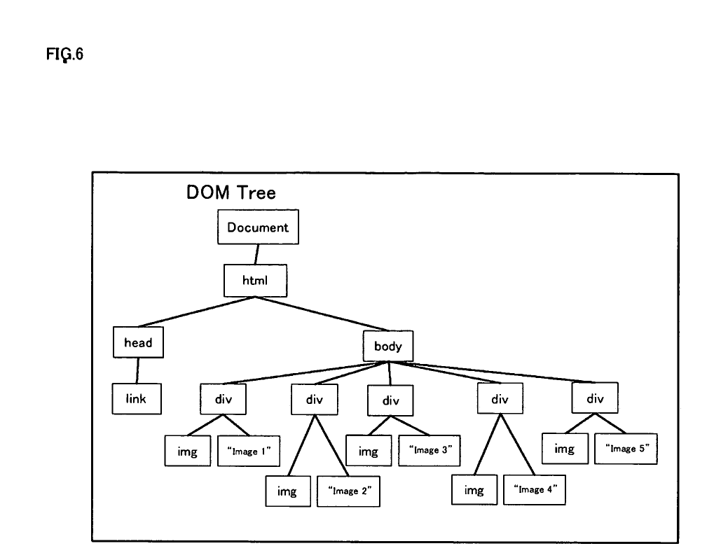

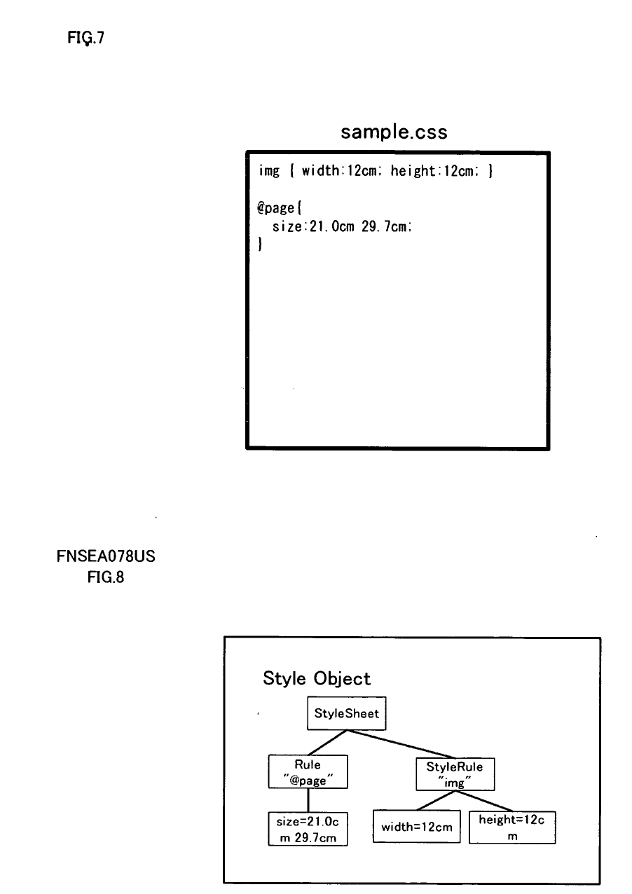

The description regards the analysis process executed by the analyzer unit 30. The analysis process is carried out according to the flowchart of FIG. 3 as mentioned above. As a matter of convenience, the description of the analysis process regards an XHTML document shown in FIG. 4 as one example. FIG. 5 shows five images stored in the JPEG format adopted in the XHTML document of the example. When the analysis layout instruction process outputs an analysis start command with a specified URL, the analyzer unit 30 reads an XHTML document identified by the specified URL (step S200) and analyzes the XHTML document to create a DOM tree (step S210). A DOM tree ID (for example, an ID prepared by adding a DOM to a URL) is assigned as identification information to the created DOM tree. According to the concrete procedure, the core 32 specifies a URL and gives an analysis request to the XML parser 34. The XML parser 34 reads the XHTML document specified by the URL and sequentially analyzes the XHTML document from the top to create respective elements and register the created elements in the form of a DOM tree. The XML parser 34 correlates the created elements and registers the correlated elements in the DOM tree storage area of the memory 50. FIG. 6 shows a DOM tree created by analysis of the XHTML document of FIG. 4.

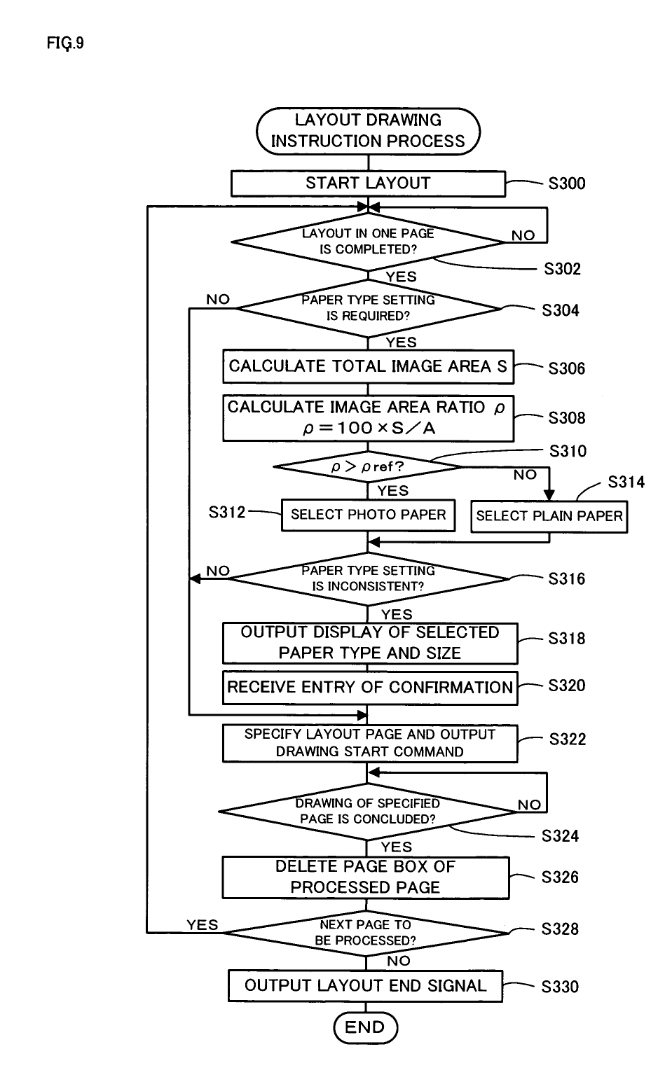

After creation of the DOM tree, the analyzer unit 30 reads a CSS document specified by the XHTML document (step S220) and analyzes the CSS document to create a style object (step S230). According to the concrete procedure, the CSSPI 36 reads the specified CSS document in response to a request given in an initialization process in a link tag of the created DOM tree, sequentially analyzes the CSS document from the top to create rules as a style object, and stores the created style object into the style object storage area of the memory 50. FIG. 7 shows a CSS document specified by the XHTML document of the example. FIG. 8 shows a style object created by analysis of this CSS document.

After creation of the DOM tree and the style object, the analyzer unit 30 correlates the DOM tree with the style object (step S240) and deletes the URL as the object of analysis from the URL storage buffer area (step S250), before terminating the analysis process.

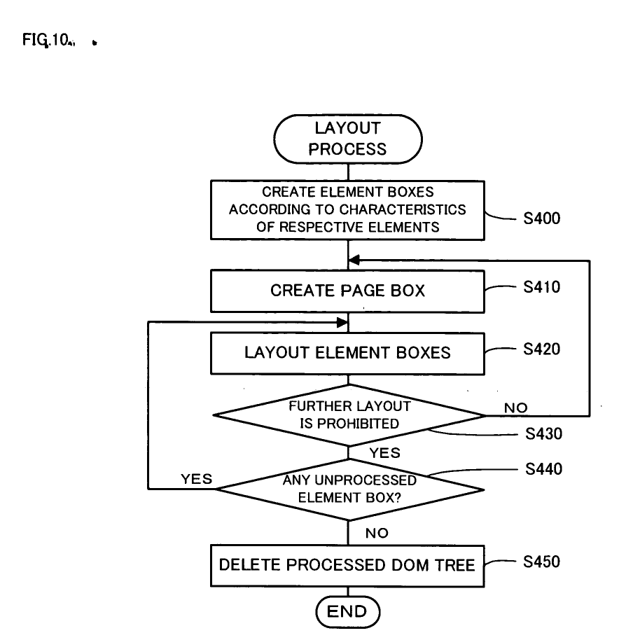

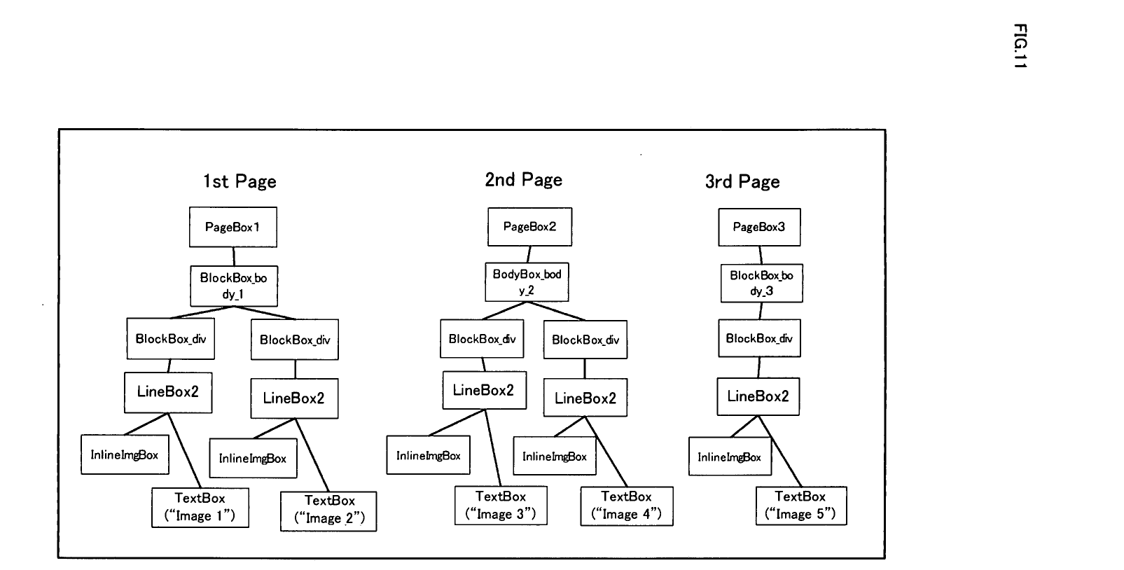

The description regards the series of processing executed by the layouter 38. FIG. 9 is a flowchart showing a layout drawing instruction process executed by the layouter 38 when the analyzer unit 30 specifies a DOM tree and outputs a layout start command. In the layout drawing instruction process, the layouter 38 starts a layout according to the specified DOM tree (step S300). The layout is made according to a layout process shown in the flowchart of FIG. 10. For convenience of explanation, the layout process is described first.

In the layout process, the layouter 38 first creates element boxes according to the characteristics of the respective elements included in the DOM tree (step S400). For example, the layouter 38 creates an image box corresponding to an image element, while creating a text box corresponding to a text element. The layouter 38 subsequently creates a page box corresponding to one page (step S410) and sequentially lays out element boxes in a body tag under the page box until prohibition of further layout (steps S420 to S440). The layout of an image box reads an image size, sets lines corresponding to the image size, and registers the image box on the lines. When the image size suggests an insufficient space for layout of the image box, further layout is prohibited at step S430. The layouter 38 accordingly creates another page box corresponding to a next page (step S410). The layout of text boxes creates a 1^{st} text box corresponding to a first part of a text receivable in one line, registers the 1^{st} text box on the line, creates a next text box corresponding to a next part of the text receivable in a next line, and registers the next text box on the next line. Such creation and registration are repeated to register all the text. In the event of failed registration of all the text to a last text box registered on a last line of one page, further layout is prohibited at step S430. The layouter 38 accordingly creates another page box corresponding to a next page and successively creates text boxes corresponding to the remaining text and registers the text boxes on respective lines in the above manner. FIG. 11 shows page boxes of respective pages as a result of layout according to the DOM tree of the example. After completion of the layout of all the element boxes, the layouter 38 deletes the specified DOM tree as the object of layout from the DOM tree storage area of the memory 50 (step S450) and terminates the layout process. The DOM tree as the object of layout is deleted from the DOM tree storage area of the memory 50 on conclusion of the layout process. This arrangement desirably prevents unnecessary storage of the processed DOM tree in the limited space of the DOM tree storage area and makes space for storage of another DOM tree created by the analyzer unit 30.

Referring back to the layout drawing instruction process (FIG. 9), the layouter 38 waits for completion of layout in a 1^{st} page (step S302) and determines whether paper type setting is required (step S304). Completion of layout in one page is detectable by determining whether a page box corresponding to a next page has been created or whether the layout process has been concluded when only one page is included in the document. The paper type is set in response to completion of layout in the 1^{st} page in this layout drawing instruction process. Namely the paper type has not yet been set immediately after completion of layout in the 1^{st} page. In response to an affirmative answer at step S304, the subsequent processing of steps S306 to S320 is executed to set the paper type.

The paper type setting flow first calculates a sum of areas of images (total image area) S among the elements laid out on the 1^{st} page (step S306), and computes an image area ratio ρ of the total image area S to a total paper area A of the currently set paper size (ρ=100×S/A) (step S308). The calculated image area ratio ρ is compared with a preset reference value ρref (step S310). In the example of FIG. 11, the total image area S of the 1^{st} page is calculated to 288 cm² by substituting the specified image size, that is, the width (12 cm) and the height (12 cm) of ‘img’ in the style object of FIG. 8, into two image boxes ‘InlineImageBox’. The image area ratio ρ is 46.2% relative to the paper size A4 Portrait (21.0×29.7). The reference value ρref is used as a criterion of selecting either the photo paper or the plain paper according to the image area ratio ρ and is set to, for example, 20% or 30%. The calculated image area ratio ρ of greater than the preset reference value ρref leads to selection of ‘Photo Paper’ as the paper type (step S312). The calculated image area ratio ρ of not greater than the preset reference value ρref, on the other hand, leads to selection of ‘Plain Paper’ as the paper type (step S314). The layouter 38 subsequently determines whether the selected paper type is inconsistent with the paper type currently set in the color inkjet printer 20 (step S316). The process of determination reads the currently set paper type written in the memory 66 of the operation unit 60 and compares the paper type selected according to the image area ratio ρ with the currently set paper type. In the case of inconsistency of the paper type, the layouter 38 outputs a display of the type and the size of printing paper to be set in the color inkjet printer 20 on the liquid crystal display 61 of the operation unit 60 (step S318) and waits for the user's press of the operation button 62 for confirmation (step S320). This terminates the paper type setting flow. In the structure of the embodiment, the output display on the liquid crystal display 61 is a message, for example, ‘Set A4 Photo Paper’. In the case of consistency of the paper type at step S316, on the other hand, the paper type setting flow is terminated without the output of the display on the liquid crystal display 61.

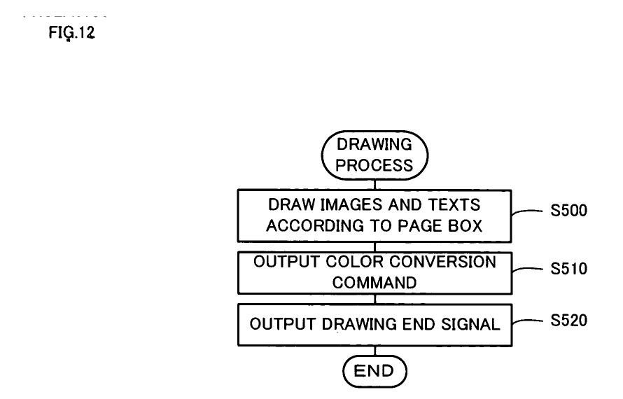

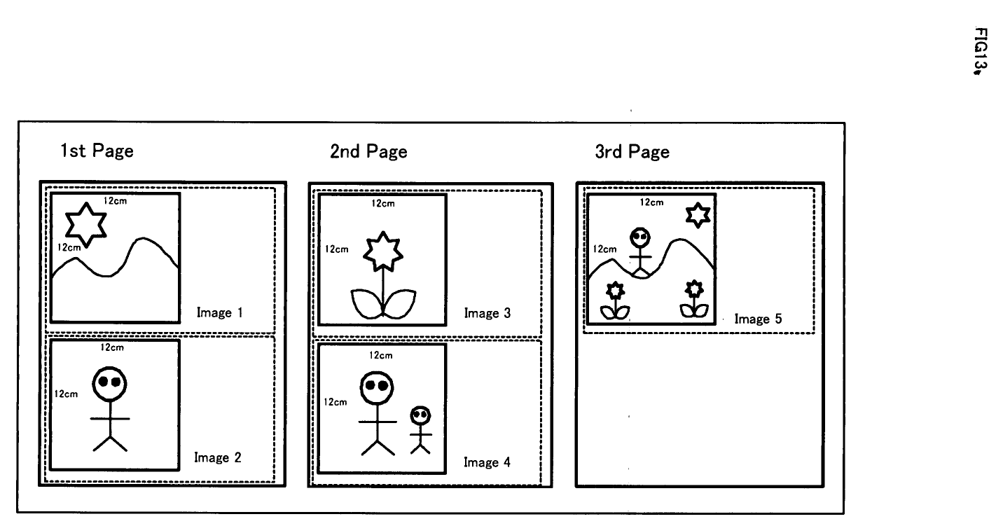

On completion of the paper type setting flow or when the layout is completed for a 2^{nd} or subsequent page and it is determined at step S304 that the paper type has been set previously, the layouter 38 specifies the layout page and outputs a drawing start command to the RPI 40 (step S322). The RPI 40 receives the drawing start command and executes a drawing process shown in the flowchart of FIG. 12. The RPI 40 draws texts and images according to the page box and stores the drawn texts and images as RGB data in the printing image storage area of the memory 50 (step S500). On completion of the drawing, the RPI 40 outputs a color conversion command to the color conversion unit 42 (step S510) and outputs a drawing end signal to the layouter 38 (step S520). The image drawing procedure reads an image file and draws an image with required processing, such as expansion, in some file formats. FIG. 13 shows a printing result of the example. The broken lines represent virtual areas of div tags included in the body tag, and the dimensions ‘12 cm’ shown on the top and the left sides of each image represent the image size described in the CSS document. The actual printing result naturally does not include the virtual areas of the div tags and the image size.

After output of the drawing start command, the layouter 38 waits for completion of drawing on the specified page (step S324) and deletes the page box corresponding to the processed page (step S326). The page box as the object of drawing is deleted on completion of drawing on the corresponding page. This arrangement desirably prevents unnecessary storage of the processed page box in the limited space of a box storage area. After deletion of the processed page box, the layouter 38 determines whether there is a next page to be processed (step S328). When there is a next page to be processed, the processing flow goes back to step S302 to wait for completion of layout in the next page, specify the next layout page, and output a drawing start command to the RPI 40. When drawing has been completed on all the pages and there is no other page to be processed, the layouter 38 outputs a layout end signal to the analyzer unit 30 (step S330) and terminates the layout drawing instruction process. The output of the layout end signal from the layouter 38 to the analyzer unit 30 enables the analyzer unit 30 to determine whether the layouter 38 is currently making a layout.

As described above, the color inkjet printer 20 of the embodiment sets the paper type according to the image area ratio ρ of the images printed on the 1^{st} page. This ensures setting of the suitable paper type for the print contents. When the paper type set according to the image area ratio ρ is inconsistent with the paper type currently set in the color inkjet printer 20, the inconsistency is shown for the user's confirmation on the liquid crystal display 61 of the operation unit 60. This arrangement effectively prevents printing on the inadequate type of printing paper. The color inkjet printer 20 reads, analyzes, and prints an XHTML document identified by a specified URL.

The analyzer unit 30 including the core 32, the XML parser 34, and the CSSPI 36 in the color inkjet printer 20 of the embodiment corresponds to the structural analysis module of the invention. The layouter 38 corresponds to the layout setting module of the invention. The processing of steps S306 to S320 in the layout drawing instruction process of FIG. 9 executed by the layouter 38 corresponds to the medium type setting module of the invention. The RPI 40, the color conversion unit 42, the binarization unit 44, the image buffer 46, and the print execution unit 48 correspond to the print execution module of the invention.

The color inkjet printer 20 of the embodiment sets the paper type according to the layout of only the 1^{st} page and does not change the setting of the paper type corresponding to the 2^{nd} and subsequent pages. One possible modification may set the paper type according to the layout of each page.

When the paper type set according to the image area ratio ρ is inconsistent with the paper type currently set in the color inkjet printer 20, the color inkjet printer 20 of the embodiment shows the inconsistency for the user's confirmation on the liquid crystal display 61 of the operation unit 60. The display of the inconsistency on the liquid crystal display 61 of the operation unit 60 for the user's confirmation may be omitted when not required.

The color inkjet printer 20 of the embodiment allows setting of only one type of printing paper. The color inkjet printer may be designed to allow simultaneous setting of two or more different types of printing papers. In this modified structure, the type of printing paper identical with the paper type set according to the image area ratio ρ is automatically selected and fed. Such modification ensures printing on the adequate type of printing paper automatically selected corresponding to the print contents.

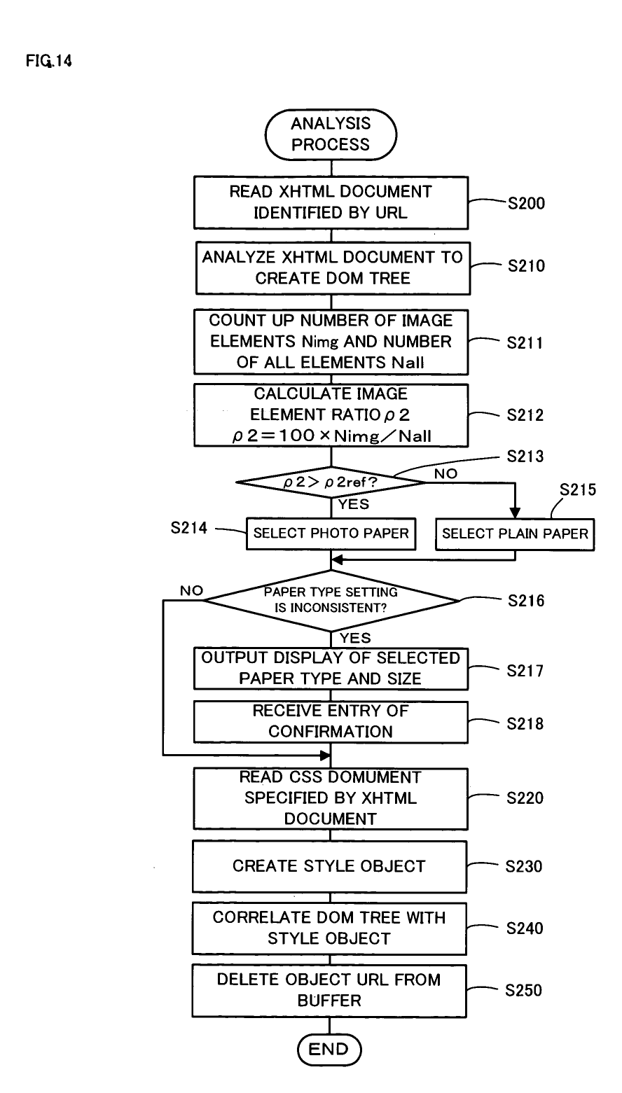

The color inkjet printer 20 of the embodiment sets the paper type according to the image area ratio ρ after layout of the 1^{st} page. One possible modification may set the paper type prior to layout. For example, the paper type may be set according to a ratio of image elements to all elements created in a DOM tree. In this case, a modified analysis process shown in the flowchart of FIG. 14 replaces the analysis process of FIG. 3. In the modified analysis process of FIG. 14, the analyzer unit 30 reads an XHTML document identified by a specified URL and analyzes the XHTML document to create a DOM tree (steps S200 and S210). The analyzer unit 30 subsequently counts up a number of image elements Nimg and a number of all elements Nall included in the created DOM tree (step S211) and calculates an image element ratio ρ2 (ρ2=100×Nimg/Nall) (step S212). In the DOM tree of FIG. 6, the number of image elements Nimg and the number of all elements Nall are equal to 5 and 10, respectively. The calculated image element ratio ρ2 is compared with a preset reference value ρ2ref (step S213). The calculated image element ratio ρ2 of greater than the preset reference value ρ2ref leads to selection of ‘Photo Paper’ as the paper type (step S214). The calculated image element ratio ρ2 of not greater than the preset reference value ρ2ref, on the other hand, leads to selection of ‘Plain Paper’ as the paper type (step S215). The reference value ρ2ref is set to, for example, 20% or 30%. The analyzer unit 30 subsequently determines whether the selected paper type is inconsistent with the paper type currently set in the color inkjet printer 20 (step S216). In the case of inconsistency of the paper type, the analyzer unit 30 outputs a display of the type and the size of printing paper to be set in the color inkjet printer 20 on the liquid crystal display 61 of the operation unit 60 (step S217) and waits for the user's press of the operation button 62 for confirmation (step S218). On completion of the paper type setting, this modified analysis process sequentially reads a CSS document specified by the XHTML document (step S220), analyzes the CSS document to create a style object (step S230), correlates the DOM tree with the style object (step S240), and deletes the URL as the object of analysis from the URL storage buffer area (step S250). This modified procedure enables the paper type to be set prior to layout. The paper type may be set at any desired timing after creation of a DOM tree, for example, after creation of a style object or after correlation of the DOM tree with the style object.

Analysis of the element type enables setting of the paper type. A further possible modification may directly count up the number of image elements Nimg and the number of all elements Nail from the identified XHTML document prior to creation of a DOM tree, and calculate the image element ratio ρ2 (ρ2=100×Nimg/Nall) from the counted number of image elements Nimg and the counted number of all elements Nall. The paper type is then set according to the calculated image element ratio ρ2. This modification enables the paper type to be set prior to even creation of a DOM tree.

When any URL is present in the URL storage buffer area of the memory 50, the color inkjet printer 20 of the embodiment successively analyzes XHTML documents, regardless of the number of DOM trees stored in the DOM tree storage area of the memory 50. When the number of DOT trees stored in the DOM tree storage area of the memory 50 reaches a preset number, analysis of a next XHTML document may be sustained until the number of the stored DOM trees decreases below the preset number. The preset number is, for example, 2. This arrangement desirably reduces the required capacity of the DOM tree storage area in the memory 50.

When any URL is present in the URL storage buffer area of the memory 50, the color inkjet printer 20 of the embodiment starts analysis of a next XHTML document immediately after completion of analysis of one XHTML document. Analysis of a next XHTML document may start at any desirable timing after completion of analysis of one XHTML document.

The color inkjet printer 20 of the embodiment analyzes and prints XHTML documents described in XHTML language. The technique of the invention is also applicable to analyze and print documents described in another markup language, as well as documents described in any language other than the markup language.

In the configuration of the embodiment, the computer 10, the digital TV receiver 12, and the digital camera 14 are connected to the input interface 22 of the color inkjet printer 20. Any other suitable devices may be connected with the color inkjet printer 20.

The above embodiment regards the color inkjet printer that analyzes and prints XHTML documents as the printing device of the invention. The technique of the invention is also applicable to diversity of other printers, for example, color laser printers, monochromatic inkjet printers, and monochromatic laser printers.

The above embodiment regards the printing device as one application of the invention. The technique of the invention may otherwise be actualized by a method of setting the type of printing paper.

The embodiment and its modified examples discussed above are to be considered in all aspects as illustrative and not restrictive. There may be many other modifications, changes, and alterations without departing from the scope or spirit of the main characteristics of the present invention.

1. A printing device that analyzes a document, which describes printable objects in a hierarchical manner, and prints the objects on a medium, such as paper, said printing device comprising:
a structural analysis module that analyzes the document to identify a type of each object and a hierarchical tree structure of the objects in the document;
a layout setting module that specifies a layout of the objects in each page on the medium, based on the identified tree structure;
a medium type setting module that sets a type of the medium according to the types of the objects in the identified tree structure; and
a print execution module that actually lays out and prints the objects in each page on the medium according to the specified layout.

2. A printing device in accordance with claim 1, wherein said medium type setting module sets the type of the medium according to the layout specified by said layout setting module.

3. A printing device in accordance with claim 2, wherein said medium type setting module sets the type of the medium according to an image object ratio in the specified layout.

4. A printing device in accordance with claim 3, wherein said medium type setting module selects a photo medium corresponding to the image object ratio of not less than a preset level, while selecting a plain medium corresponding to the image object ratio of less than the preset level.

5. A printing device in accordance with claim 1, said printing device further comprising a medium feeder module that has an attachment unit for separately setting multiple different types of media in said printing device, said medium feeder module selecting a certain type of medium identical with the type of the medium set by said medium type setting module and feeds the selected type of medium to said print execution module.

6. A printing device in accordance with claim 1, said printing device further comprising a medium type output module that has an output unit for outputting a type of medium in an identifiable manner, said medium type output module outputting the type of the medium set by said medium type setting module in an identifiable manner to said output unit.

7. A printing device that analyzes a document, which describes printable objects, and prints the objects on a medium, such as paper, said printing device comprising:
an object type identification module that analyzes the document to identify a type of each object described in the document; and
a medium type setting module that sets a type of the medium according to the identified types of the objects.

8. A printing device in accordance with claim 7, wherein said medium type setting module sets the type of the medium according to a ratio of image objects to all the objects of the identified types.

9. A printing device in accordance with claim 8, wherein said medium type setting module selects a photo medium corresponding to the image object ratio of not less than a preset level, while selecting a plain medium corresponding to the image object ratio of less than the preset level.

10. A printing device in accordance with claim 7, said printing device further comprising a medium feeder module that has an attachment unit for separately setting multiple different types of media in said printing device, said medium feeder module selecting a certain type of medium identical with the type of the medium set by said medium type setting module and feeds the selected type of medium to said print execution module.

11. A printing device in accordance with claim 7, said printing device further comprising a medium type output module that has an output unit for outputting a type of medium in an identifiable manner, said medium type output module outputting the type of the medium set by said medium type setting module in an identifiable manner to said output unit.

12. A medium type setting method that sets a type of a medium, such as paper, in the process of analyzing a document, which describes printable objects in a hierarchical manner, and printing the objects on the medium, said medium type setting method comprising the steps of:
(a) analyzing the document to identify a type of each object and a hierarchical tree structure of the objects in the document;
(b) specifying a layout of the objects in each page on the medium, based on the identified tree structure; and
(c) setting a type of the medium according to the types of the objects in the identified tree structure and the specified layout.

13. A medium type setting method that sets a type of a medium, such as paper, in the process of analyzing a document, which describes printable objects, and printing the objects on the medium, said medium type setting method comprising the steps of:
(a) analyzing the document to identify a type of each object described in the document; and
(b) setting a type of the medium according to the identified types of the objects.
